(19) United States
(12) Patent Application Publication
(10) Pub. No.: US 2020/0358888 A1
(43) Pub. Date: Nov. 12, 2020

(54) PORTABLE ELECTRONIC DEVICE

(71) Applicant: PRIMAX ELECTRONICS LTD., Taipei City (TW)

(72) Inventors: SHIH-JUNG HUANG, Taipei City (TW); TUNG-SHENG TSAI, Taipei City (TW)

(21) Appl. No.: 16/518,372

(22) Filed: Jul. 22, 2019

(30) Foreign Application Priority Data
May 10, 2019 (TW) 108116270

(51) Int. Cl. H04M 1/02; G06F 3/01; G06F 3/0488; H04W 4/02; G06K 9/00

(52) U.S. Cl. CPC H04M 1/0264; G06F 3/017; H04W 4/80; H04W 4/02; G06K 9/00664; G06F 3/0488

(57) ABSTRACT

A portable electronic device includes a casing, a display module, a wide-angle lens module and a microphone module. The casing has an inclined surface. The inclined surface is located at an end of the casing. The wide-angle lens module acquires an environment image. The microphone module acquires an environmental sound. The portable electronic device judges whether at least one moving object is approaching a user of the portable electronic device at a fast speed according to the environment image and the environmental sound.

### FIELD OF THE INVENTION

The present invention relates to an electronic device, and more particularly to a portable electronic device.

### BACKGROUND OF THE INVENTION

With the advent of the Internet age, people can use electronic devices to communicate and interact with each other at any time and in any place. For example, electronic devices can be used to make calls, make video conferences, transfer messages or transfer photos. However, the excessive use of the electronic device not only affects the mind and body, but also exposes the user to the dangerous environments. For example, when the pedestrian or passerby uses the portable electronic devices intently, they usually ignore the surrounding environment. Consequently, traffic accidents occur easily.

For overcoming the above drawbacks, it is important for reducing the occurrence of the traffic accidents while the pedestrian or passerby uses the portable electronic devices.

### SUMMARY OF THE INVENTION

The present invention provides a portable electronic device for increasing the safety of the pedestrian or passerby. In case that a moving object is approaching, the portable electronic device generates a warning signal. In response to the warning signal, the user pays attention to the surrounding situation immediately and takes the precaution measurement. Consequently, the possibility of generating the traffic accident is reduced.

In accordance with an aspect of the present invention, a portable electronic device is provided. The portable electronic device includes a casing, a display module, a wide-angle lens module and a microphone module. The casing has a first surface, a second surface and an inclined surface. The second surface is opposed to the first surface. The inclined surface is located at an end of the casing and connected with the second surface. The display module is disposed in the first surface. The wide-angle lens module is disposed in the inclined surface to acquire an environment image. The microphone module is disposed in the inclined surface and located beside the wide-angle lens module. The microphone module acquires an environmental sound. The portable electronic device judges whether at least one moving object is approaching a user of the portable electronic device at a fast speed according to the environment image and the environmental sound.

In an embodiment, the casing has an accommodation space. A portion of the accommodation space is formed in the inclined surface. The wide-angle lens module is accommodated within the accommodation space.

In an embodiment, another portion of the accommodation space is extended from a junction between the inclined surface and the second surface to a portion of the second surface.

In an embodiment, the portable electronic device analyzes and recognizes the at least one moving object in the environmental image. If an image of the at least one moving object is enlarged quickly and a decibel number of the environmental sound is increased quickly, the portable electronic device judges that the at least one moving object is approaching the user quickly and generates a warning signal to warn the user.

In an embodiment, the display module is a liquid crystal display module, a light-emitting diode display module, an organic light-emitting diode display module, a micro light-emitting diode display module, a quantum dot display module or a field emission display module.

In an embodiment, the portable electronic device has a touch control function, and the touch control function is a resistive touch control function, a capacitive touch control function, a sonic touch control function, an optical touch control function or an electromagnetic touch control function.

In an embodiment, the portable electronic device further includes a motion sensor, and the motion sensor is disposed within the casing. The motion sensor detects whether the portable electronic device is in a moved state.

In an embodiment, the motion sensor includes a dynamic sensing module. The dynamic sensing module is a gravity sensing module or a gyroscope.

In an embodiment, the motion sensor includes a positioning module. The positioning module is a global positioning module, a Bluetooth positioning module, a Wi-Fi positioning module or a GPRS/CDMA positioning module.

In an embodiment, the portable electronic device is a personal digital assistant, a smart phone or a video game console.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a portable electronic device according to an embodiment of the present invention and taken along a viewpoint;

FIG. 1B is a schematic perspective view illustrating a portable electronic device according to another embodiment of the present invention and taken along another viewpoint;

FIG. 2 schematically illustrates a usage scenario of the portable electronic device according to the embodiment of the present invention; and

FIG. 3 schematically illustrates an environmental image captured by the portable electronic device of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

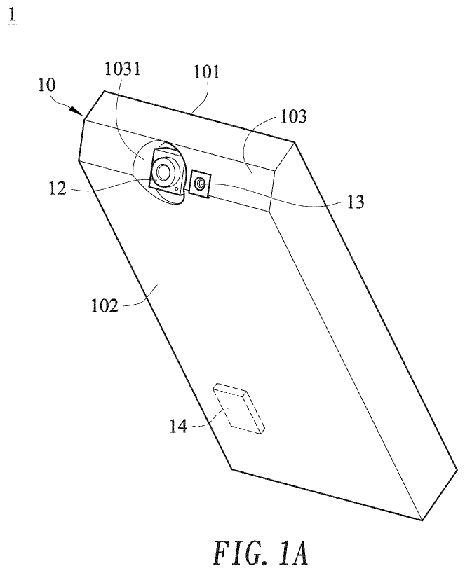

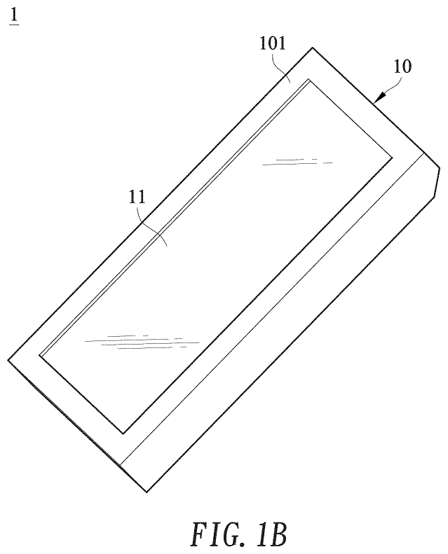

Please refer to FIGS. 1A and 1B. FIG. 1A is a schematic perspective view illustrating a portable electronic device according to an embodiment of the present invention and taken along a viewpoint. FIG. 1B is a schematic perspective view illustrating a portable electronic device according to another embodiment of the present invention and taken along another viewpoint. In this embodiment, the portable electronic device 1 is a smart phone. The portable electronic device 1 comprises a casing 10, a display module 11, a wide-angle lens module 12, a microphone module 13 and a motion sensor 14. In the embodiment, the portable electronic device 1 is a smart phone. It is noted that the example of the portable electronic device 1 is not restricted. For example, the portable electronic device 1 is a personal digital assistant (PDA), a video game console or any other appropriate electronic device that is operable at any time.

The casing 10 has a first surface 101, a second surface 102 and an inclined surface 103. The first surface 101 and the second surface 102 are opposed to each other. The inclined surface 103 is located at an end of the casing 10 and connected with the second surface 102. In an embodiment, the casing 10 has an accommodation space 1031. A greater portion of the accommodation space 1031 is formed in the inclined surface 103. Moreover, a smaller portion of the accommodation space 1031 is extended from the junction between the inclined surface 103 and the second surface 102 to a portion of the second surface 102. The wide-angle lens module 12 is accommodated within the accommodation space 1031. In an embodiment, a lens surface (not shown) of the wide-angle lens module 12 is located at the same level with the inclined surface 103 or the second surface 102. In another embodiment, the lens surface of the wide-angle lens module 12 is located at the same level lower than the inclined surface 103 or the second surface 102. Due to this design, the abrasion or damage of the wide-angle lens module 12 from the contact between the wide-angle lens module 12 and the surrounding environment will be minimized. The microphone module 13 is disposed in the inclined surface 103 and located beside the wide-angle lens module 12. Due to the inclined arrangement of the wide-angle lens module 12 and the microphone module 13, the portable electronic device 1 can acquire the environment image and the environmental sound along the horizontal direction.

The display module 11 has a touch control function. The display module 11 is disposed in the first surface 101. An example of the display module 11 includes but is not limited to a liquid crystal display (LCD) module, a light-emitting diode (LED) display module, an organic light-emitting diode (OLED) display module, a micro LED display module, a quantum dot display module or a field emission display (FED) module. The touch control function is a resistive touch control function, a capacitive touch control function, a sonic touch control function, an optical touch control function or an electromagnetic touch control function. An operation interface is shown on the display module 11. The wireless communication signal strength, the time, the Bluetooth indication, the battery status, the icon of the application program, the mail status, the caller ID, the missed call or any other appropriate message can be shown on the operation interface. The user may touch the display module 11 to operate an application program, set a system status of the portable electronic device 1, open/reply mail or dial a phone number. Alternatively, the user may touch the display module 11 to control the wide-angle lens module 12 to the environmental image or control the microphone module 13 to acquire the environmental sound

The motion sensor 14 is disposed within the casing 10. The motion sensor 14 can detect whether the portable electronic device 1 is in a moved state. For example, if the pedestrian or passerby with the portable electronic device 1 is walking on the sidewalk or zebra crossing, the portable electronic device 1 is in the moved state. In an embodiment, the motion sensor 14 comprises a dynamic sensing module such as a gravity sensing module or a gyroscope. In another embodiment, the motion sensor 14 comprises a positioning module such as a global positioning module, a Bluetooth positioning module, a Wi-Fi positioning module or a GPRS/CDMA positioning module.

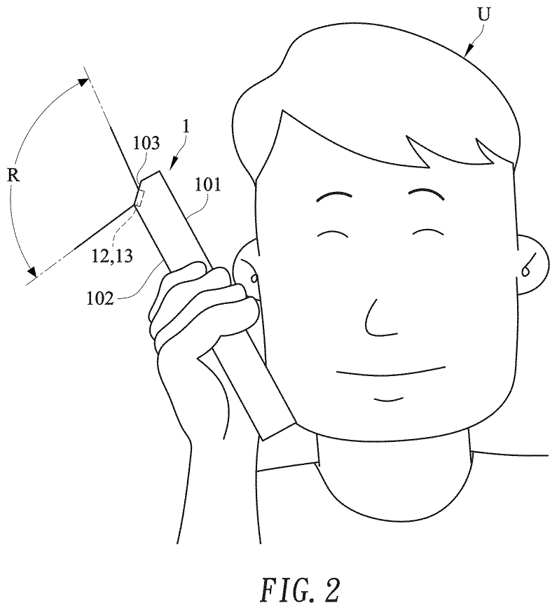

FIG. 2 schematically illustrates a usage scenario of the portable electronic device according to the embodiment of the present invention. As shown in FIG. 2, the face of the user U is in close contact with the portable electronic device 1 or the user U is operating the display module 11 of the portable electronic device 1 (see FIG. 1B). Moreover, the user U is walking on the sidewalk or zebra crossing while using the portable electronic device 1 to make a call. Under this circumstance, the motion sensor 14 detects that the portable electronic device 1 is in the moved state. Meanwhile, the wide-angle lens module 12 and the microphone module 13 in the inclined surface 103 of the portable electronic device 1 are enabled. Consequently, the wide-angle lens module 12 acquires an environmental image within a wide-angle range R. In addition, the microphone module 13 acquires the environmental sound along a specified direction within the wide-angle range R. According to the environmental image acquired by the wide-angle lens module 12 and the environmental sound acquired by the microphone module 13, the portable electronic device 1 can judge whether a moving object is approaching the user U of the portable electronic device 1 at a fast speed.

In the above example, the wide-angle lens module 12 and the microphone module 13 are enabled when the portable electronic device 1 is being used and moved by the user. It is noted that the timing of enabling the portable electronic device 1 is not restricted. For example, in another embodiment, the wide-angle lens module 12 and the microphone module 13 are enabled when the portable electronic device 1 is being used by the user U, regardless of whether the user U is moving or not moving.

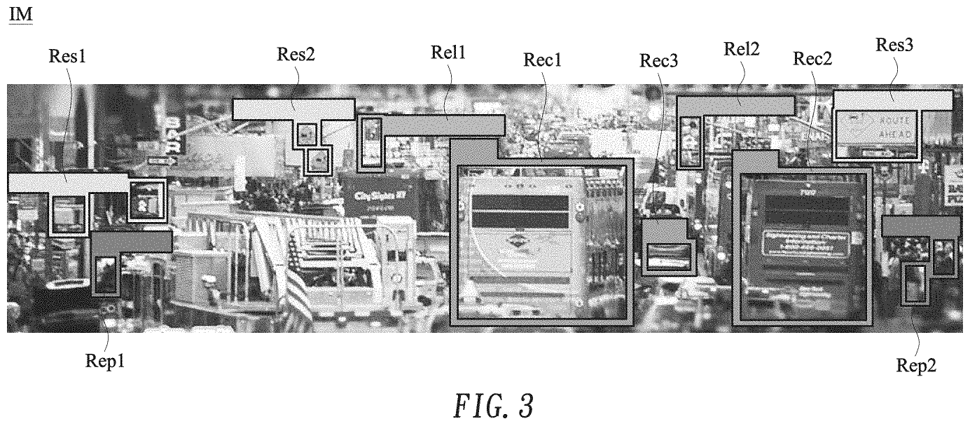

FIG. 3 schematically illustrates an environmental image captured by the portable electronic device of the present invention. Please refer to FIGS. 2 and 3. After the wide-angle lens module 12 of the portable electronic device 1 shoots the environment within the wide-angle range R continuously, plural environmental images IM are acquired. In FIG. 3, one of the environmental images IM is shown. Then, an application program installed in the portable electronic device 1 analyzes the environmental images IM. After analyzing the environmental images IM, the portable electronic device 1 recognizes the moving objects in the environmental images IM and recognizes the environment conditions. For example, the moving objects include the cars Rec1, Rec2, Rec3 and the pedestrians Rep1, Rep2, and the environment conditions include the traffic signs Res1, Res, Res3, the traffic lights Rel1, Rel2 and other traffic conditions. After the continuously-captured environmental images IM and the environmental sound captured by the microphone module 13 are analyzed, the portable electronic device 1 analyzes the cars Rec1, Rec2 and Rec3 in the environmental images IM and judges whether the cars Rec1, Rec2 and Rec3 are approaching the user U of the portable electronic device 1. For example, if the image of the car Rec1, Rec2 or Rec3 in the environmental images IM is enlarged quickly and the decibel number (dB) of the environmental sound is increased quickly, the portable electronic device 1 judges that the car Rec1, Rec2 or Rec3 is approaching the user U and generates a warning signal immediately. In an embodiment, the warning signal is a warning image shown on the display module 11. In another embodiment, the warning signal is a warning sound generated by a built-in speaker (not shown) of the portable electronic device 1. In response to the warning signal, the user pays attention to the surrounding situation immediately and takes the precaution measurement. Consequently, the possibility of generating the traffic accident is reduced. In some embodiments, the information about the traffic accident can be updated or downloaded from a cloud server through a built-in wireless transmission module (not shown) of the portable electronic device 1. For example, the information includes the types of cars or traffic conditions corresponding to the higher possibility of causing the traffic accident or the injury of the pedestrian or passerby. Consequently, the portable electronic device 1 can analyze and judge the moving objects in the environmental images IM more accurately.

From the above descriptions, the present invention provides the portable electronic device. The wide-angle lens module and the microphone module are disposed in the inclined surface to acquire the environmental image and the environmental sound, respectively. According to the environmental image and the environmental sound, the portable electronic device judges whether a moving object is approaching at a fast speed. In response to the warning signal, the user pays attention to the surrounding situation immediately. Consequently, the possibility of causing the traffic accident is effectively reduced. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A portable electronic device, comprising:
a casing having a first surface, a second surface and an inclined surface, wherein the second surface is opposed to the first surface, and the inclined surface is located at an end of the casing and connected with the second surface;
a display module disposed in the first surface;
a wide-angle lens module disposed in the inclined surface, and acquiring an environment image; and
a microphone module disposed in the inclined surface and located beside the wide-angle lens module, wherein the microphone module acquires an environmental sound,
wherein the portable electronic device judges whether at least one moving object is approaching a user of the portable electronic device at a fast speed according to the environment image and the environmental sound.

2. The portable electronic device according to claim 1, wherein the casing has an accommodation space, wherein a portion of the accommodation space is formed in the inclined surface, and the wide-angle lens module is accommodated within the accommodation space.

3. The portable electronic device according to claim 2, wherein another portion of the accommodation space is extended from a junction between the inclined surface and the second surface to a portion of the second surface.

4. The portable electronic device according to claim 1, wherein the portable electronic device analyzes and recognizes the at least one moving object in the environmental image, wherein if an image of the at least one moving object is enlarged quickly and a decibel number of the environmental sound is increased quickly, the portable electronic device judges that the at least one moving object is approaching the user quickly and generates a warning signal to warn the user.

5. The portable electronic device according to claim 1, wherein the display module is a liquid crystal display module, a light-emitting diode display module, an organic light-emitting diode display module, a micro light-emitting diode display module, a quantum dot display module or a field emission display module.

6. The portable electronic device according to claim 5, wherein the portable electronic device has a touch control function, and the touch control function is a resistive touch control function, a capacitive touch control function, a sonic touch control function, an optical touch control function or an electromagnetic touch control function.

7. The portable electronic device according to claim 1, wherein the portable electronic device further comprises a motion sensor, and the motion sensor is disposed within the casing, wherein the motion sensor detects whether the portable electronic device is in a moved state.

8. The portable electronic device according to claim 7, wherein the motion sensor comprises a dynamic sensing module, and the dynamic sensing module is a gravity sensing module or a gyroscope.

9. The portable electronic device according to claim 7, wherein the motion sensor comprises a positioning module, and the positioning module is a global positioning module, a Bluetooth positioning module, a Wi-Fi positioning module or a GPRS/CDMA positioning module.

10. The portable electronic device according to claim 1, wherein the portable electronic device is a personal digital assistant, a smart phone or a video game console.
